(19) United States
(12) Patent Application Publication
(10) Pub. No.: US 2014/0026184 A1
(43) Pub. Date: Jan. 23, 2014

(54) METHOD FOR CONFIGURING PERSONAL DATA DISTRIBUTION RULES

(71) Applicants: David Pergament, Boulogne Billancourt (FR); Armen Aghasaryan, Nozay (FR); Jean Gabriel Ganascia, Paris (FR)

(72) Inventors: David Pergament, Boulogne Billancourt (FR); Armen Aghasaryan, Nozay (FR); Jean Gabriel Ganascia, Paris (FR)

(73) Assignee: ALCATEL LUCENT, Paris (FR)

(21) Appl. No.: 14/009,968

(22) PCT Filed: Mar. 12, 2012
(86) PCT No.: PCT/EP12/54718

§ 371 Date: Oct. 4, 2013

(30) Foreign Application Priority Data
Apr. 5, 2011 (FR) 1152934

(51) Int. Cl. G06F 21/62

(52) U.S. Cl. CPC G06F 21/6245
USPC 726/1

(57) ABSTRACT

The invention pertains to a method for configuring rules for distributing personal data of a social network user (U) with respect to a target contact (CC). The method consists of retrieving behavioral data of the target contact. Based on this retrieved behavioral data and a sensitivities profile defined by the user, an assessment grade is assigned to the target contact with respect to the danger that he or she represents of propagating the user's personal data. Based on the grade assigned to the target contact, a recommendation to configure the rules for distributing his or her personal data is issued to the user.

The present invention pertains to the domain of social networks and the distribution of personal data within those social networks.

More particularly, the invention pertains to a method for configuring rules for the distribution of the personal data of a user of a social network. The invention also pertains to a system for configuring rules for the distribution of the personal data of a user of a social network, to an application server, and to a computer program product.

Social networking sites enable millions of users around the world to open an account, to create a profile and to publish on those sites personal data or information related to their private life. Each user of a social network creates his or her own network within which he or she accepts relationships, also known as contacts in the remainder of the description, with other users. These contacts may be grouped by nature. Thus, for example, a user may have contacts belonging to the group of his or her family members, or the group of his or her very close friends, or the group of his or her more distant friends, or the group of his or her co-workers. The user may also accept strangers who have asked to join his or her network of contacts. Each user is able to control the visibility of his or her personal data by the other users of the social network, whether or not they are his or her contacts. Thus, a user may decide to share only some personal data with a few contacts in his or her network. A social network therefore enables its users to enter personal data related to their own private lives and to interact with other users. The information that may be made available to the network essentially pertains to relationship status, education, or occupation, or other centers of interest. This information then makes it possible to find users who share the same centers of interest. In this situation, the use of social networks extends solely to the sharing of personal data, related to one's private life, through photographs, links, or text messages, for example. But those social networks may also be used to create public groups in order to build awareness of institutions, businesses, and various causes. Interactions between members of such groups include the sharing of correspondence and multimedia documents in particular. In such a case, all of the data published in these public groups is, unlike the profile, public, and may be viewed by anyone without it being necessary to have an account on the social network in question. Since this data is public, it may be used by anyone without the consent of its owner, for advertising, phishing, or identity theft, for example.

Furthermore, some users, particularly the youngest ones, want to meet as many people as they can who are similar to themselves and share the same centers of interest. This is why they allow access to their personal data without restrictions. Their personal data may then be distributed by contacts in their networks, then by contacts of their contacts who do not belong to their own network, and so on. Likewise, a contact, even a very close one, may use his or her profile for commercial purposes, or a contact who does not have a good understanding of how social networks function might not correctly set his or her privacy settings, making his or her profile public and becoming a sharer without knowing it. In such cases, users no longer have control over their own data, which might be distributed widely, and may be reused afterward without their consent. The personal data of users is particularly used by advertisers to send targeted advertisements. Social networks may also legally resell information about their members, not just their profile, but also their consumer behavior, in order to better tailor the advertising even further. Some companies also retrieve publicly available personal data to collect information about their employees. Recruiters can also collect information and use it to select their candidates. Public or government organizations may also collect information and add to their files. There are so-called “reputation” websites that enable any Internet users to obtain third-party descriptions by searching for and collecting information publicly available on the web. Finally, due to the spread of their personal data, the users also incur a high risk of identity theft.

Other users are more risk-averse, and do not want to insert their personal data there, out of fear that it will be used without their consent or be stolen.

It is therefore very important to be able to define rules for distributing personal data, so that the users of social networks retain control over their own personal data, relating to their private life.

There are currently systems that provide services to users of social networks in order to alert them as to how their data is meant to be protected. One of those systems is the subject matter of patent application US2011/0029566. The system described in this document analyzes whether a user's personal data is visible to each of his or her contacts. It then analyzes how sensitive the data is. Thus, the more sensitive data is deemed to be, the more it must be preserved and kept from being distributed. To do so, the system distinguishes between well-defined attribute fields, meaning, e.g. date of birth, telephone number, personal address, line of work, etc. It is also based on the nature of the user's relationships with each of his or her contacts, meaning that it takes into account the relationships in a different way depending on whether the contacts belong to a group identified as being family, or a group of close friends, or a group of distant friends, or a group of co-workers, for example. Next, the system gives the user the option of configuring in a comprehensive manner how restrictive it is in terms of the privacy of his or her personal data related to his or her private life. To do so, the user chooses whether or not to give access to certain attribute fields, depending on the nature of his or her relationships with his or her contact groups, i.e. based on his or her trust in each contact group.

However, existing systems are only based on the user's data, in accordance with how restrictive he or she wants it be in terms of privacy. These systems do not make it possible to refine the rules for distributing personal data based on a contact's behavior and said contact's ability to propagate data.

One purpose of the invention is therefore to remedy at least one of the shortcomings of the prior art. In particular, the invention aims to make it possible to assess the danger that a social network user's contact potential may represent, to share personal data deemed sensitive by the user.

To that end, a subject matter of the invention is a method for configuring rules for distributing a social network user's personal data with respect to a target contact, said personal data being classified in categories, said method comprising the steps consisting of:
defining a profile of the user's sensitivities by ranking said personal data categories and assigning a weight to behavioral factors, based on a degree of importance that the user accords them with respect to public distribution,

retrieving behavioral data from said target contact,

estimating a grade for each behavioral factor of said target contact, based on said retrieved behavioral data, each behavioral factor being scored for each personal data category ranked in said sensitivities profile of said user,

aggregating the estimated grades by taking into account the weight assigned to each of said behavioral factors of the sensitivities profile, to obtain an overall grade assigned to the target contact for the personal data categories as a whole and for each of them individually,

issuing a configuration recommendation to said user in order to configure rules for distributing personal data with respect to said target contact based on the overall grades.

Thus, the method makes it possible to assign an assessment grade to the target contact, and to establish a configuration recommendation to the user, based on the assessment of the danger that the target contact represents to propagating the data.

According to other optional characteristics of the method:

the calculation of grades is also refined through a collaborative exchange of grades with at least one contact in common between said user and said target contact,

the issuing of a recommendation consists of issuing an alert message proposing to block access to a personal data category for said target contact, if the overall grade obtained for said personal data category is less than a predetermined threshold value,

the threshold value is modified based on a decision of said user of whether or not to follow said issued recommendation,

the retrieval of behavioral data of said target contact is achieved by means of contacts in common between said user and said target contact, and by means of publicly available data,

the sensitivity profile of said user is automatically edited based on requests made by said user to display the grades assigned to the target contact.

The invention further pertains to a system for configuring rules for distributing a social network user's personal data with respect to a target contact, said personal data being ranked in categories, characterized in that said system comprises:

an input means enabling said user to define a sensitivities profile by ranking said personal data categories and assigning a weight to behavioral factors, based on a degree of importance that the user accords them with respect to public distribution,

a request module capable of retrieving behavioral data of said target contact,

a calculation module capable of estimating and assigning a grade to predetermined behavioral factors of said target contact, based on said retrieved behavioral data, each behavioral factor being graded for each personal data category ranked in said sensitivities profile of said user,

an aggregation module capable of aggregating the estimated grades by taking into account the weight assigned to each of said behavioral factors of the sensitivities profile, to obtain an overall grade assigned to the target contact for the personal data categories as a whole and for each of them individually,

a recommendation module capable of issuing a recommendation to said user for configuring rules for distributing personal data with respect to said target contact based on the overall grades obtained.

According to other optional characteristics of the system:

the system further comprises a learning module (80) capable both of editing the configuration decision rules, based on a decision of said user of whether or not to follow said issued recommendation, and of editing the sensitivities profile of said user based on a request of said user for displaying grades assigned to the target contact,

the system further comprises a filtering module capable of establishing a match between the ranked personal data categories of said sensitivities profile of the user and the behavioral data of said target contract retrieved by said request module.

The invention further pertains to an application server comprising at least one microprocessor and a memory for implementing the configuration method as described above.

Finally, the invention pertains to a computer program product intended to be loaded in a memory of an application server, the computer program product comprising software code portions implementing the method as described above, when the program is run by a processor of the application server.

Thus, the invention makes it possible to improve the privacy and/or secure control of the distribution of personal data regarding a user without requiring encryption of personal data. Consequently, the invention constitutes a simple, effective alternative that does not require the use of encryption algorithms requiring significant software and hardware resources (particularly in terms of processors and memory) in order to avoid an uncontrolled release of personal data. It is therefore well-suited to the context of social networks.

Other advantages and characteristics of the invention will become apparent upon reading the following description given by way of a non-limiting example, with reference to the attached figures, which represent:

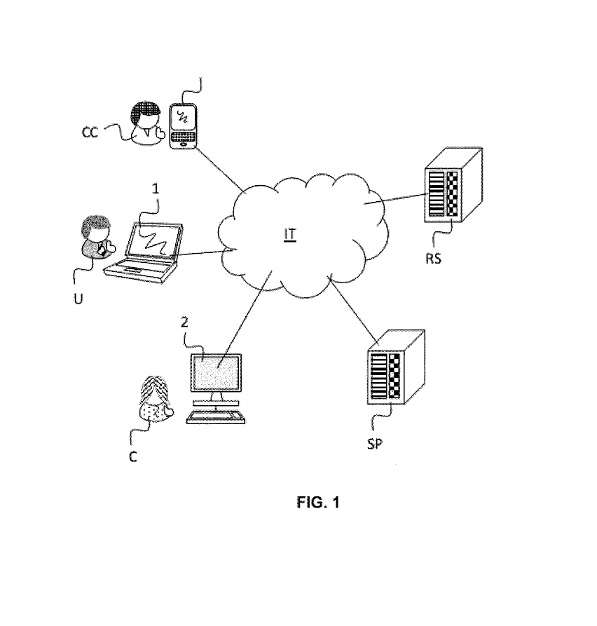

FIG. 1, a simplified diagram of a social network in which users meet,

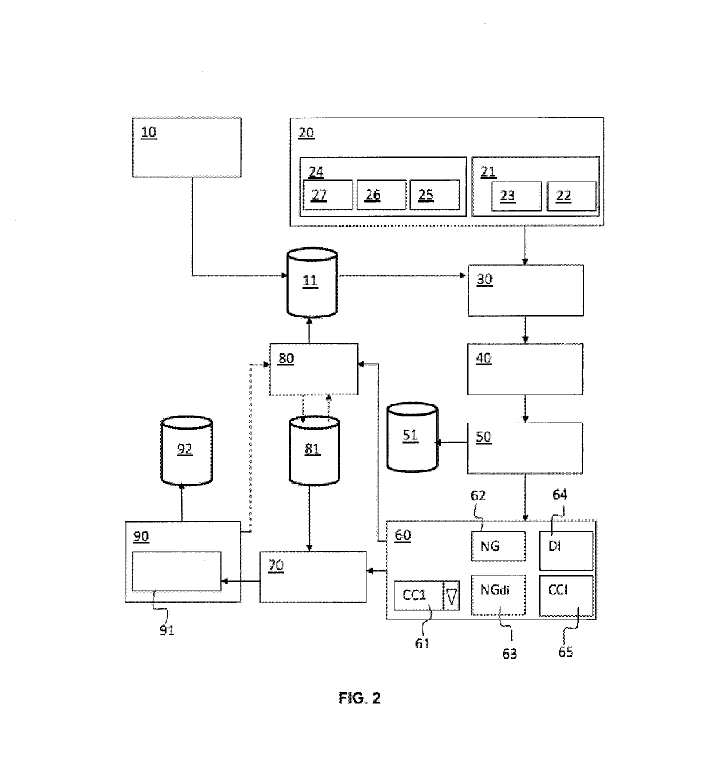

FIG. 2, a diagram of a system for configuring rules for distributing personal data of a social network user, with respect to a target contact,

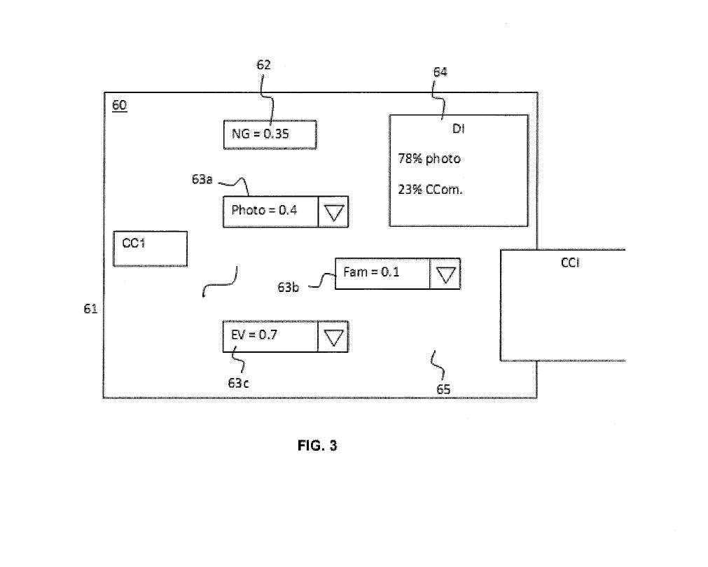

FIG. 3, a diagram of a graphical user interface for displaying grades estimated by the system of FIG. 2, for a selected target contact,

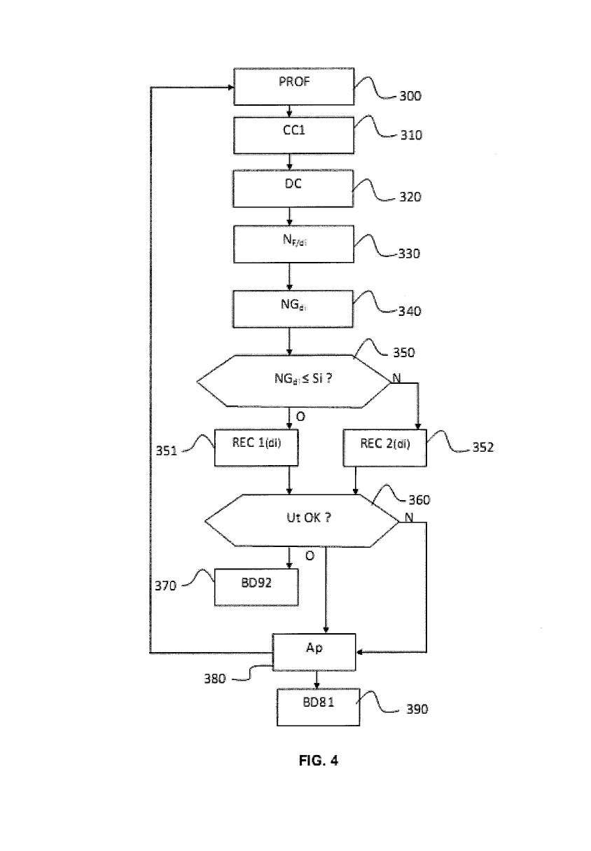

FIG. 4, a flowchart depicting the steps of the method implemented by the system of FIG. 2.

In the remainder of the description, the term “user” refers to a social network user who has opened an account, created his or her profile to publish personal data there, and created a network of contacts comprising different contact groups. A target contact is defined as being another user of said social network who wants to join the user's network of contacts, or whom the user plans to add, or whom the user has already added to his or her network of contacts.

FIG. 1 depicts a network, whereby users U, C, CC connect their respective computers 1, 2, 3 to a remote social networking server RS. A user U then meets contacts C and CC of the social network. He or she may want to add a target contact CC to his or her network of contacts. In such a case, the user logs in via a telecommunication network IT to a remote configuration server SP operative to implement the inventive configuration method.

The system depicted FIG. 2 makes it possible to assist the user in configuring his or her rules for distributing his or her personal data, based on an assessment of the danger that the target contact represents for spreading said data. To do so, the system analyzes behavioral data of the target contact.

FIG. 2 is described in parallel with FIG. 4 to clarify the role of each functional module of the system in the configuration method. In a first step 300, the user first defines his or her sensitivity profile PROF in terms of distributing personal data, related to his or her private life. To do so, an input means 10, coming for example in the form of a graphical user interface that appears on his or her computer's screen, enables the user to define that profile PROF. Thus, for each predetermined group of data, the user ranks the personal data categories that he or she believes are more or less relevant and to which he or she accords more or less importance with respect to distribution. The data categories believed to be important, or sensitive, are the data categories that the user does not want to have propagated across a global telecommunication network such as the web.

A first group taken into account to produce this profile, known as “themes”, includes all topics covered by the user, placing them into themed categories. Thus, within this group, the user may be vigilant with respect to distributing his or her personal data regarding themed categories about his or her family or politics, and he or she accords those topics a high degree of importance. On the other hand, he or she may accord less or no importance to a sports category, for example. In such a case, the user ranks the themed categories by order of importance, in a drop-down menu for example. Thus, in the example, the user puts the family topic first, the politics topic second, and the sports topic last.

A second group, known as “object types”, includes types of content, placed into different categories that define how a piece of data is published. These content type categories vary from one social network to another. The most common in social networks are, for example, photos, videos, statuses, events, or groups. In his or her sensitivities profile, the user therefore defines which object type categories are more or less important to him or her. Thus, he or she may accord more importance to photos than to a status. In this case as well, he or she ranks each object type, based on the importance that he or she accords to it.

Furthermore, when defining his or her sensitivities profile, the user also takes into account another data group, known as “behavioral factors”. This group includes different categories of behavior that a target contact may have with regard to respecting privacy. These different behavioral categories are, for example, easily propagating data that does not belong to the target contact, or the way in which the target contact distributes data, particularly if feelings are expressed during the distribution, or not setting rules with regard to respecting privacy when the target contact creates his or her profile within a social network. This way, the user may accord more importance to a propensity-to-propagate factor, which assesses the dangers that a target contact represents for propagating personal data. Other factors take into account the target contact's popularity, the way he or she propagates data, whether the target contact cites other contacts when distributing data, etc. Those factors are detailed below in connection with the calculation module. The user then awards a weight, or grade of importance, which may be between 0 and 1, such as 0.4 for instance, the lowest grade being deemed less important than the highest grade. Thus, depending on the degree of permissibility that he or she accords to each of the behaviors that a target contact may have, the user assigns them a weight.

The user therefore defines his or her sensitivities profile by ranking the personal data categories and by weighting behavioral factors, based on the importance that the user accords to said personal data categories and to said behavioral factors with respect to public distribution.

In one variant, the user may also associated a theme with an object type. Thus, for example, he or she may define that the data on the subject of his or her family in the object type “photos” is sensitive, while regarding that same subject, the object type “status” is not, for example. In this case as well, it is possible to assign a weight to that association between 0 and 1.

The sensitivities profile thereby defined by the user is advantageously saved in a storage means 11. This storage means may be remote, and be in the form of a database, for example.

In step 310, the user then selects a target contact CC1 for whom he or she wants to assess the danger represented in terms of distributing data. This selection of the target contact may be done by means of a graphical user interface that appears on the screen of his or her computer. This graphical user interface is referenced 60 in FIGS. 2 and 3. The selection of the target contact then triggers the operation of a request module 20.

This request module 20 makes it possible to retrieve, in step 320, complementary data DC related to the selected target contact, with respect to which the user wishes to set rules for distributing his or her personal data. To do so, the module 20 is broken down into two entities 21 and 24. The first entity 21 makes it possible to collect data publicly available on the web. Thus, a first collector 22 searches the web to see if there is any information available about the behavior of the target contact, with regard to respecting privacy rules. That collector may, for example, verify whether the target contact owns a website, and whether the settings of that website, in terms of respecting personal data, are high or low. Another collector 23 makes it possible to retrieve information from social networks that the target contact is a member of, but for which he or she has not set any rules with regard to respecting privacy and distributing his or her personal data. That collector 23 may also retrieve information from social networks, and more particularly, from public profiles, meaning unconfigured profiles of users of those networks with whom the target contact has interacted. The second entity 24 retrieves behavioral data about the target contact from the user's network of contacts. Thus, a first collector 25 makes it possible to retrieve data about the target contact directly from his or her profile, that is visible to the user. In this case, the user must then be in a specific relationship with the target contact, meaning that he or she has already added him or her to his or her network of contacts. Another collector 26 consists of collecting data regarding the target contact based on information retrieved from contact profiles shared between the user and the target contact. In such a case, the user and the target contact do not need to be in a direct relationship. Information held by the shared contacts will be used. Thus, for example, the collector 26 may access comments that the target contact had made regarding subjects held by the shared contacts. Finally, another collector 27 may retrieve assessment grades, calculated by the user's contacts, to qualify the target contact in terms of protecting and respecting privacy. In such a case, the grades calculated and visible in the shared contact profiles are, for example, obtained with that same system.

The data retrieved in this way is transmitted to a filtering module 30. The sensitivity profile saved in the means of storage 11 is also transmitted to the filtering module. That filtering module 30 makes it possible, based on behavioral data DC retrieved by the various data collectors 22, 23, 25, 26, 27 of the request module 20, and on data related to the user's sensitivities profile, to establish a match between the data categories ranked by the user and the behavioral data DC of the selected target contact CC1. Thus, all of the data for which a match could not be established is not retained for the later step of estimating grades. The data for which a match was established is retained, and is transmitted to the input of the following functional module 40. That filtering module 30 is optional, it makes it possible to facilitate later estimates by eliminating all data for which no match could be established. To conduct its analyses, establish its matches, and perform its filtering, the module 30 is advantageously based on semantic analysis techniques.

A calculation module 40 then makes it possible, in step 330, to estimate and assign a grade N_{F/di} to predetermined behavioral factors of the target contact CC1. To do so, the calculation module 40 is based on data transmitted by the filtering module 30. A behavioral factor is associated with each personal data category ranked in the sensitivity profile, and for each of those associations, a grade N_{F/di} is assigned to it. Thus, for each theme and each object type selected by the user in his or her sensitivities profile, a grade is estimated and assigned to the propensity factor of the target contact to propagate data, and so on for each behavioral factor.

With respect to estimating the grade of the propensity factor to propagate data, the calculation module 40 includes, based on the data provided to it, the number of times that the target contact commented or tagged objects, for example, such as photo or video or status links, that were not his or her own. The more frequently the target contact does so, the higher the grade assigned to the factor is. For example, when propagating a status, the intensity of the propagation is measured by taking into account the number of times that the target contact propagated the object, the number of times that other users also propagated the object, and the number of users who saw the object without propagating it. Thus, when the target contact has posted three comments regarding a status for example, the grade of the propensity to propagate the object type “status” will be higher than if he or she had posted only one comment. Likewise, whenever the target contact clicks on a button of the “like” type under an object type published by himself/herself or one of his/her contacts, that enables his or her contacts to know what he or she appreciates. Thus, if multiple contacts press the “like” button for a particular status, for example, then that status will be heavily propagated, and the grade of the propensity to propagate will therefore be high.

The popularity factor represents the popularity of the target contact in comparison to baseline measures. Those baseline measures may, for example, be defined as the average behavior of the user's contacts. In particular, the grade assigned to that popularity factor is based on the number of contacts that the target contact has in its network of relationships, the percentage of people present within an “event” object that the target contact has created, or the number of times that the object type has been propagated.

The sensitivity factor represents a sentence's degree of neutrality. The degree of neutrality may be measured using conventional emotion extraction techniques, e.g. smiley detection, smileys being stylized drawings of faces used to express emotions. The degree of neutrality of all terms in a sentence may also be analyzed using statistical dictionaries, such as, for example, the “SentiWordnet” (registered trademark) dictionary that maybe viewed at the web address http://sentiwornet.isti.cnr.it. The aggregation of the grades assigned to each of the terms in the phrase gives the phrase's grade. The more extreme the grade is, i.e. the closer to 0 or 1, the more sensitive the phrase is deemed to be. A grade of 0.5 means that the target contact remains neutral when propagating his or her messages, and does not transmit his or her feelings. This factor is important, because it reveals the quality of the propagation when personal feelings are propagated.

The exposure factor makes it possible to deduce whether the target contact configured his or her personal data distribution settings in a private or public sense. It makes it possible to help the user tell whether he or she can interact risk-free with the target contact.

In order to assign a grade to the distribution factor, the calculation module is based on the number of times that the target contact's data talks about third parties. To do so, it analyzes, for example, the contents of the messages mentioning third parties as well as the photos that are marked, or tagged, with his or her contacts. In such a case, the calculation module analyzes the percentage of contacts in question, the number of times they are cited, etc. The proximity factor represents the target contact's proximity with respect to the user. Finally, the propensity to facilitate distribution factor makes it possible to tell whether the target contact has facilitated access to already-propagated data.

Some factors analyze only behavioral data that does not belong to the target contact, such as the propensity to propagate, while others only take into account behavioral data belonging to the target contact, such as the exposure factor, and others combined the two of them, such as the sensitivity factor, for example. In one variant, it may be beneficial to calculate the grades of certain factors by taking into account all behavioral data, regardless of relationships with themed categories or object types, for example to calculating the grade of the proximity factor between the user and the target contact.

The grades N_{F/di} estimated in this way are then transferred to an aggregator module 50. This model makes it possible to calculate (step 340) an overall assessment grade NG_{di} associated with the target contact CC1, for all personal data categories rank in the sensitivities profile, and also for each of those personal data categories. This overall grade NG_{di} reflects the behavior of the selected target contact CC1, with respect to the protection of personal data, meaning that it makes possible to assess the danger of the target contact propagating the user's personal data. This aggregator module 50, in one embodiment, may be combined with the calculation module 40. It calculates an overall grade by aggregating all the grades estimated by the calculator modules 40 for each behavioral factor associated with a personal data category. The aggregation takes into account the weight of each behavioral factor as defined in the user's sensitivities profile. The higher the behavioral factors are weighted in the sensitivities profile, the more sensitive they are deemed for the user, and the more impact they have on the value of the overall grade. The calculation is therefore weighted based on the importance accorded to various behavioral factors by the user.

In one embodiment, the grades may also be estimated collaboratively. This is because two users in contact, who have a highly trusting relationship and who share a lot of data, may exchange grades that they estimated for the same target contact and combine them in order to further refine their estimates. As a result, optionally and with the approval of his or her contact(s), the user retrieves the grade assigned to the target contact by his or her contact(s) and checks whether the information is relevant to him or her. For example, he or she may take into account the number of contacts that took into account that collaborative calculation, or that grade's added value, to include it significantly in his or her estimate. In return, the user sends the grade that he or she had estimated to his or her contact(s). This retrieval of grades in order to perform a collaborative calculation is carried out by the collector 27 of the request module 20 as previously described.

Whenever grades are assigned in this way for the target contact, they are advantageously saved in a storage means 51. This storage means may, for example, be a database. This database also stores the context in which the estimates were carried out. The context may, for example, cite the contacts who contributed to the grade estimates. This way, the grades for each target contact of the user are stored and no longer need to be recalculated each time. Additionally, this database may make it possible to revisit a grade when it is necessary to recalculate it. This may, for example, be the case when the user adds new contacts to his or her user who are shared in common with the target contact.

The grades obtained in this way are advantageously displayed, by means of the graphical user interface 60 for example, which appears on the screen of the user's computer. This interface 60 is the one that had previously served to select the target contact CC1. It is schematically depicted in FIG. 3. It makes possible to show the user the grades assigned to the target contact whom he or she is considering adding to his or her network of contacts. Once the user selects a target contact CC1, in a selection menu 61, the operation of the system is triggered by that interface. The user may use that interface after having received an invitation from a target contact whom he or she does not know, or if he or she wishes to obtain more information about a person who is already in his or her network of contacts. This makes it possible to better set his or her settings for distributing his or her personal data. The grades obtained are transmitted by the aggregator module 50 and are displayed on the interface 60. A first field 62 displays the overall grade NG obtained for the target contact CC1 for all personal data categories. In the example in FIG. 3, the overall grade NG assigned to the target contact CC1 is equal to 0.35. Other fields 63a, 63b, 63c show the overall grades NG_{di} obtained, for topics and object types. Thus, in the example of FIG. 3, the field 63a displays a grade equal to 0.4 for the object type “photo”. The field 63b shows a grade of 0.1 for the subject of family Fam and the field 63c shows a grade equal to 0.7 for the object type “event” EV. These three grades therefore mean that the selected target contact CC1 tends to vary widely propagate data regarding the subject of family, and also distributes photos, but it distributes less of the object type “event”. These fields 63 particularly display grades in an order corresponding to the user's preferences, i.e. based on the topics and object types most relevant to him or her. The results are also displayed based on their values. This interface also enables the user to view all the grades that were estimated, not just the most relevant ones, particularly owing to drop-down menus.

Additionally, the user may want to know how the grade was awarded. That's why, when selecting a grade, for example the grade 0.4 assigned to the photo object in FIG. 3, two other windows 64, 65 appear. A first window 64 displays public data DI belonging to the target contact and obtained directly from the target contact's profile or from other public sites. Thus, the window may, for example, display the percentage of photos that the target contact tagged, 78% in the example in FIG. 3, and the percentage, 23% in the example of FIG. 3, of tagged shared contacts CCom. This window may also show a status, for example, to highlight some of the data that was used to generate the grade. A second window 65 shows the behavioral data of the target contact that does not belong to the target contact and was obtained through shared contacts CCI with which he or she has interacted. These two windows are an example display. The data may be displayed in another way, for example in multiple windows, each window being tied to a collector 22, 23, 25, 26, 27 of the request module 20.

The grades thereby obtained are both transmitted to a recommendation module 70 and to a learning module 80. The user's browser history in the interface 60 for displaying grades is advantageously transmitted to the learning module Ap 80. Thus, the display history data make it possible to better understand and grasp the user's sensitivities. Thus, if the user often asks to display information about a particular topic that was not considered important in his or her sensitivities profile 11, its importance will then be raised and updated in his or her sensitivities profile 11 PROF, so that that data is displayed among the leading ones in future instances.

The operation of the recommendation module 70, meanwhile, is triggered by the interface 60, when the user asks to display recommendations to configure his or her options for configuring rules for distributing his or her personal data. This module 70 therefore makes it possible to set a recommendation strategy by comparing the grades assigned to the target contact with threshold values predefined in the decision rules, contained within a means of storage 81 such as a database, for example. This database 81 contains basic decision rules that may be applied by default. Such a rule may, for example, consist of stating that if the obtained grade NG_{di}, for a particular object type, is less than a threshold value Si, for example 0.75, then the target contact might not have access to data of that object type. Otherwise, he or she can have access to it. The decision rules, stored in the database 81, are transmitted to the recommendation module 70 and, based on the grades that are transmitted to it, it issues one or more recommendation(s) REC1(di), REC2(di) to the user (steps 350, 351, 352). Thus, in one example, the grade NG_{di} obtained for the photo object is 0.4 and below a predefined threshold value Si of 0.75 for that object (step 350). In this case, the recommendation module 70 issues a recommendation REC1 (step 351) consisting of stating that it must not give access to the photo object to the contact CC1. On the other hand, if the grade obtained for the event project is, for example, 0.7, and greater than the predefined threshold value Si of 0.6 for that object, for example, then the recommendation module 70 issues a recommendation REC2 for the event object consisting of stating that the user may give access to that object to the target contact CC1 (step 352).

The recommendations issued with regard to configuring rules for distributing personal data with respect to the target contact are then viewed in another window 91 of another graphical user interface 90 that appears on the user's screen. The user may then follow those recommendations (step 360) and, if so, its own distribution rules with respect to the target contact, stored in a storage means of the database type 92, will automatically be updated (step 370). He or she may also reject the recommendation. In both cases, the learning module 80 is informed of the user's decision (step 380) and updates (step 390) the decision rules contained in the database 81, so that the next time the system's behavior will better meet the user's desires. For example, if a recommendation consists of preventing the target contact from accessing the “photo” object type and the user gives him or her access anyway, the threshold value Si of the grade for that object type is lowered in the corresponding decision rule.

In another embodiment, the two means 11 and 81 for storing the user's sensitivities profile and the decision rules respectively may be combined into a single database.

The Figures and their above descriptions illustrate the invention rather than limit it.

Although some Figures show different functional entities as distinct blocks, this does not in any way exclude embodiments of the invention in which a single entity/module performs multiple functions, or multiple entities/modules perform a single function. The functions of various elements depicted in the Figures, particularly functional blocks marked as “processing modules” or “processors”, may be constructed through the use of dedicated hardware such as hardware capable of running a computer program in connection with an appropriate computer program. When the function is performed by a processor, it may be performed by a single dedicated processor, or by a single shared processor, or by a plurality of individual processors, some of which may be shared. The databases mentioned or depicted may be centralized or distributed. Thus, the Figures must be considered a highly schematic illustration of the invention.

1. A method for configuring rules for distributing a social network user's personal data with respect to a target contact, said personal data being ranked in categories, the method comprising:
defining a profile of the user's sensitivities by ranking said personal data categories and assigning a weight to behavioral factors, based on a degree of importance that the user accords them with respect to public distribution,
retrieving behavioral data from said target contact,
estimating a grade for each behavioral factor of said target contact, based on said retrieved behavioral data, each behavioral factor being scored for each personal data category ranked in said sensitivities profile of said user,
aggregating the estimated grades by taking into account the weight assigned to each of said behavioral factors of the sensitivities profile, to obtain an overall grade assigned to the target contact for the personal data categories as a whole and for each of them individually,
issuing a configuration recommendation to said user in order to configure rules for distributing personal data with respect to said target contact based on the overall grades.

2. A method according to claim 1, wherein the calculation of grades is also refined through a collaborative exchange of grades with at least one contact in common between said user and said target contact,

3. A method according to claim 1, wherein the issuing of a recommendation consists of issuing an alert message proposing to block access to a personal data category for said target contact, if the overall grade obtained for said personal data category is less than a predetermined threshold value.

4. A method according to claim 3, wherein the threshold value is modified based on a decision of said user of whether or not to follow said issued recommendation.

5. A method according to claim 1, wherein the retrieval of behavioral data of said target contact is achieved by means of contacts in common between said user and said target contact, and by means of publicly available data.

6. A method according to claim 1, wherein the sensitivity profile of said user is automatically edited based on requests made by said user to display the grades assigned to the target contact.

7. A system for configuring rules for distributing a social network user's personal data with respect to a target contact, said personal data being ranked in categories, wherein said system comprises:
an input means enabling said user to define a sensitivities profile by ranking said personal data categories and assigning a weight to behavioral factors, based on a degree of importance that the user accords them with respect to public distribution,
a request module capable of retrieving behavioral data of said target contact,
a calculation module capable of estimating and assigning a grade to predetermined behavioral factors of said target contact, based on said retrieved behavioral data, each behavioral factor being graded for each personal data category ranked in said sensitivities profile of said user,
an aggregation module capable of aggregating the estimated grades by taking into account the weight assigned to each of said behavioral factors of the sensitivities profile, to obtain an overall grade assigned to the target contact for the personal data categories as a whole and for each of them individually,
a recommendation module capable of issuing a recommendation to said user for configuring rules for distributing personal data with respect to said target contact based on the overall grades obtained.

8. A system according to claim 7, further comprising a learning module capable both of editing the configuration decision rules, based on a decision of said user of whether or not to follow said issued recommendation, and of editing the sensitivities profile of said user based on a request of said user for displaying grades assigned to the target contact.

9. A method according to claim 7, further comprising a filtering module capable of establishing a match between the ranked personal data categories of said sensitivities profile of the user and the behavioral data of said target contract retrieved by said request module.

10. An application server comprising at least one microprocessor and a memory for implementing the method according to claim 1.

11. A computer program product intended to be loaded in a memory of an application server, the computer program product comprising software code portions implementing the method as described above, when the method according to claim 1 is run by a processor of the application server.
